(19) United States
(12) Patent Application Publication
(10) Pub. No.: US 2026/0364944 A1
(43) Pub. Date: Nov. 19, 2026

(54) INKJET PRINTING APPARATUS AND CLEANING METHOD THEREOF

(71) Applicant: MIYAKOSHI PRINTING MACHINERY CO., LTD., Narashino-city, Chiba (JP)

(72) Inventors: Mizuki SUGAHARA, Yachiyo-city (JP); Wataru ITABASHI, Yachiyo-city (JP); Choko KATANO, Yokote-shi (JP)

(21) Appl. No.: 19/466,304

(22) Filed: Jan. 31, 2026

(30) Foreign Application Priority Data
May 13, 2025 (JP) 2025-080758

(51) Int. Cl. B41J 2/165; B41J 2/175; B41J 2/18; B41J 2/20

(52) U.S. Cl. CPC B41J 2/16552; B41J 2/17596; B41J 2/18; B41J 2/20; B41J 2002/16573; B41J 2002/16594

(57) ABSTRACT

A partially cleanable inkjet printing apparatus includes buffer tank storing liquid, head unit ejecting the liquid, and first and second flow paths circulating the liquid between the buffer tank and the head unit. The apparatus further includes a cleaning liquid tank for storing cleaning liquid and a waste liquid unit for discharging the cleaning liquid after cleaning. A first three-way valve is provided in the first flow path, and a second three-way valve is provided in the second flow path. A cleaning liquid flow path supplies the cleaning liquid from the cleaning liquid tank to the first three-way valve, and a waste liquid flow path guides the cleaning liquid from the second three-way valve to the waste liquid unit. By switching the flow paths of the first and second three-way valves, ink or cleaning liquid can be selectively supplied to the head unit, enabling partial cleaning of the printing apparatus.

### TECHNICAL FIELD

The present invention relates to an inkjet printing apparatus and a cleaning method thereof, more specifically, to an inkjet printing apparatus whose ink flow paths can be cleaned partially and a cleaning method thereof.

### Background Art

For inkjet printing apparatus, stable ink ejection is extremely important from the viewpoint of maintaining the quality of printed matter.

However, in industrial use inkjet printing apparatus, if the ink stays for a long time, sometimes the dispersed solids, such as the titanium oxide pigment, aggregate and settle. In this case, the aggregates may clog the nozzle, causing clogging.

In order to solve this problem, some inkjet printing apparatus equipped with a flow path for circulating ink in order to adjust the temperature of the ink and prevent the ink from settling have been developed.

For example, the inkjet printing apparatus described in the Patent Literature 1 is an inkjet printing apparatus which has a circulation flow path for circulating ink, and is equipped with: a printing unit which has multiple print heads forming nozzles for ejecting the above-mentioned ink and a distribution tank for storing the above-mentioned ink for distributing to the said multiple print heads; a buffer tank for storing the above-mentioned ink; a heat exchanger for adjusting the temperature of the above-mentioned ink; a manifold for branching the flow path of the above-mentioned ink; a main circulation pipe sequentially connecting the above-mentioned buffer tank, the above-mentioned heat exchanger, and the above-mentioned manifold; a sub-circulation pipe connecting the above-mentioned manifold and the above-mentioned buffer tank; a supply circulation pipe connecting the above-mentioned manifold and the above-mentioned printing unit; a recovery circulation pipe connecting the above-mentioned printing unit and the above-mentioned buffer tank; pumps placed in the above-mentioned sub-circulation pipe, the above-mentioned supply circulation pipe, and the above-mentioned recovery circulation pipe respectively for circulating the above-mentioned ink; and whose first circulation flow path is formed by the above-mentioned main circulation pipe and the above-mentioned sub-circulation pipe for circulating ink, and whose second circulation flow path is formed by the above-mentioned main circulation pipe, above-mentioned supply circulation pipe, and the above mentioned recovery circulation pipe for circulating ink.

Also, when an inkjet printing apparatus is not used for a long time, the ink in the inkjet printing apparatus is replaced with a cleaning liquid or the like in order to prevent aggregation and settling of the solids in the ink as mentioned above.

The inkjet apparatus of Patent Literature 2 is equipped with: an inkjet head that ejects ink; an ink tank that stores the above-mentioned ink; an outbound path that transports the above-mentioned ink from the above-mentioned ink tank to the above-mentioned inkjet head; an inbound path that transports the above-mentioned ink from the above-mentioned inkjet head to the above-mentioned ink tank; a bypass flow path that transports the above-mentioned ink from the above-mentioned outbound path to the above-mentioned inbound path without passing through the above-mentioned inkjet head; a cleaning flow path that supplies cleaning liquid to the above-mentioned inkjet head and recovers the above-mentioned cleaning liquid from the above-mentioned inkjet head; and a switching unit configured to be able to switch between a circulation state in which the above-mentioned ink is circulated through a circulation path including the above-mentioned outbound path, the above-mentioned inkjet head, the above-mentioned inbound path, and the above-mentioned ink tank, and a cleaning state in which the above-mentioned ink head is cleaned by circulating the above-mentioned cleaning liquid through a circulation path including the above-mentioned outbound path, above-mentioned bypass flow path, above-mentioned inbound path, and above-mentioned ink tank, and at the same time, via the above-mentioned cleaning flow path, by supplying the above-mentioned cleaning liquid to the above-mentioned inkjet head and recovering the above-mentioned cleaning liquid from the above-mentioned inkjet head.

By the way, when printing is resumed by an inkjet printing apparatus in which ink has been replaced with cleaning liquid or the like, the cleaning liquid or the like is replaced with ink before printing is resumed.

### Citation List

### Patent Literature

Patent Literature 1 Unexamined Patent Publication No. 2020-147003
Patent Literature 2 Unexamined Patent Publication No. 2018-030047

### Summary of Invention

### Technical Problem

When ink is replaced with a cleaning liquid as described in the Patent Literature 2, if the replacement is insufficient, the solids of the ink remaining in the flow path may clog the flow path.

On the other hand, when printing is resumed and if the replacement of the cleaning liquid with ink is insufficient, problems such as the ink being diluted with the cleaning liquid and the ink concentration becoming low may occur.

However, when replacing ink with cleaning liquid in the entire flow path, a large amount of ink or cleaning liquid is required. In addition, the replacement work takes a long time. Therefore, results are in poor operational efficiency in terms of consumables and time.

Furthermore, if the printing interruption is not too long, it may be sufficient to replace ink with cleaning liquid in the head and its surrounding area only, which are most susceptible to clogging; however, the apparatuses of Patent Literatures 1 and 2 are not capable of selective replacement of these flow paths.

The present invention has been developed in consideration of the above circumstances, and aims to provide an inkjet printing apparatus equipped with cleaning function for ink flow paths, and also, capable of selecting flow paths to be cleaned and a cleaning method thereof.

### Solution to Problem

The inventors conducted extensive research to solve the above problems, and discovered that the above problems could be solved by equipping with a three-way valve in respective first flow paths that make ink flow from the buffer tank to a head unit and respective second flow paths that make ink flow from a head unit to the buffer tank, and by further equipping with a cleaning liquid flow path and a waste liquid flow path, which led to the completion of the present invention.

The present invention is a partially cleanable inkjet printing apparatus 100 whose liquid flow paths can be cleaned partially, and equipped with: a buffer tank 1 for storing liquid; a head unit 4 for ejecting the liquid; a first flow path P1 that makes liquid flow from the buffer tank 1 to the head unit 4; a second flow path P2 that makes liquid flow from the head unit 4 to the buffer tank 1; a cleaning liquid tank 2 for storing cleaning liquid; a waste liquid unit 3 for discharging the cleaning liquid after cleaning; a first three-way valve V1 placed in the first flow path P1; a second three-way valve V2 placed in the second flow path P2; a cleaning liquid flow path P3 connected to the first three-way valve V1 and makes the cleaning liquid flow from the cleaning liquid tank 2 to the first three-way valve V1; and a waste liquid flow path P4 connected to the second three-way valve V2 and makes the liquid flow from the second three-way valve V2 to the waste liquid unit 3; and by switching the flow paths in the first three-way valve V1 and the second three-way valve V2, when the liquid is ink, ink can flow to the head unit 4 and when the liquid is a cleaning liquid, cleaning liquid can flow to the head unit 4.

The present invention resides in the inkjet printing apparatus 100 described above whose head unit 4 has an IN-side distribution tank 41, a head 42 into which liquid flows from the IN-side distribution tank 41, and an OUT-side distribution tank 43 which liquid flows out from the head 42, and a first flow path P1 makes liquid flow from the buffer tank 1 to the IN-side distribution tank 41, and a second flow path P2 makes liquid flow from the OUT-side distribution tank 43 to the buffer tank 1.

The present invention resides in the inkjet printing apparatus 100 described above, which is further equipped with: an auxiliary flow path P5 that makes liquid flow from the IN-side distribution tank 41 to the buffer tank 1, an auxiliary three-way valve V3 placed in the auxiliary flow path P5, and an auxiliary waste liquid flow path P6 connected to the auxiliary three-way valve V3 and makes liquid flow from the auxiliary three-way valve V3 to the waste liquid unit 3, and by switching the flow paths in the first three-way valve V1, the second three-way valve V2, and the auxiliary three-way valve V3, if the liquid is ink, ink can be circulated to the head unit 4, and if the liquid is cleaning liquid, cleaning liquid can be circulated to the head unit 4.

The present invention resides in the inkjet printing apparatus 100 described above, which is further equipped with a circulation three-way valve V4 placed upstream of the first three-way valve V1 on the first flow path P1, and a circulation flow path P7 connected to the circulation three-way valve V4 which makes liquid flow from the circulation three-way valve V4 to the buffer tank 1, and by switching the flow path in the circulation three-way valve V4, liquid is supplied from the buffer tank 1 to the head unit 4, or liquid is circulated from the buffer tank 1 to the buffer tank 1.

The present invention resides in the inkjet printing apparatus 100 described above, which is further equipped with a liquid supply source 5 for supplying liquid and a supply flow path P8 that circulates liquid from the liquid supply source 5 to the buffer tank 1, and the liquid supply source 5 has an ink supply source 51 for supplying ink as the liquid, and a purified water supply source 52 for supplying purified water as the liquid, and when the liquid supply source 5 is the ink supply source 51, ink flows through the supply flow path P8 as a liquid, and when the liquid supply source 5 is the purified water supply source 52, purified water flows through the supply flow path P8 as a liquid.

The present invention resides in the inkjet printing apparatus 100 described above, in which the cleaning liquid is water containing a solvent or a surfactant, and the purified water is water not containing a solvent or a surfactant.

The present invention resides in a cleaning method 200 for the inkjet printing apparatus 100 described above, which has a first cleaning process S1 in which the cleaning liquid in the cleaning liquid tank 2 is made to flow from a cleaning liquid flow path P3 to a first flow path P1 via a first three-way valve V1 and then circulates through the head unit 4 thereby cleaning the head unit 4 and a second cleaning process S2 in which the cleaning liquid that has circulated through the head unit 4 is made to flow from the head unit 4 to a second flow path P2, and from the second flow path P2 to a waste liquid flow path P4 via the second three-way valve V2 to flow into a waste liquid unit 3 for discharge.

The present invention resides in a cleaning method 200 for the inkjet printing apparatus 100 described above, in which the second cleaning process S2 makes the cleaning liquid that has flowed from the head unit 4 to the second flow path P2 flow into the buffer tank 1 via the second three-way valve V2, and when the amount of cleaning liquid stored in the buffer tank 1 reaches an upper limit, makes the cleaning liquid flow from the second flow path P2 to a waste liquid flow path P4 via the second three-way valve V2, and then into the waste liquid unit 3 for discharge.

The present invention resides in a cleaning method 200 for the inkjet printing apparatus 100 described above, which has a first cleaning process S1 in which the cleaning liquid in the cleaning liquid tank 2 is made to flow from the cleaning liquid flow path P3 to the first flow path P1 via the first three-way valve V1 and then circulate to the head unit 4, thereby cleaning the head unit 4, and a second cleaning process S2 in which the cleaning liquid that has circulated to the head unit 4 is made to flow from the head unit 4 to the second flow path P2, and from the second flow path P2 to the waste liquid flow path P4 via the second three-way valve V2, and then, into the waste liquid unit 3 for discharge, and at the same time, the auxiliary three-way valve V3 makes the cleaning liquid flow from the auxiliary flow path P5 to the auxiliary waste liquid flow path P6, and then into the waste liquid unit 3 for discharge.

The present invention resides in a cleaning method 200 for the inkjet printing apparatus 100 described above, in which, when the inkjet printing apparatus 100 is stopped for longer than a certain period of time determined arbitrarily, a purified water supply source 52 is attached as the liquid supply source 5 instead of the ink supply source 51 and by circulating purified water instead of ink, full cleaning is performed, and when the inkjet printing apparatus 100 is stopped for less than the certain period of time, partial cleaning is performed which includes a first cleaning process S1 in which the cleaning liquid in the cleaning liquid tank 2 is made to flow from a cleaning liquid flow path P3 to a first flow path P1 via a first three-way valve V1 and then into the head unit 4 to clean the head unit 4, and a second cleaning process S2 in which the cleaning liquid that has circulated to the head unit 4 is made to flow from the head unit 4 to a second flow path P2, and then from the second flow path P2 to a waste liquid flow path P4 via the second three-way valve V2, and then into a waste liquid unit 3 for discharge.

The present invention may be implemented by appropriately combining the above.

### Advantageous Effects of Invention

The inkjet printing apparatus 100 of the present invention is equipped with a first flow path P1, a second flow path P2, a cleaning liquid tank 2 in which cleaning liquid is stored, a first three-way valve V1, a second three-way valve V2, a cleaning liquid flow path P3, and a waste liquid flow path P4, and switching the flow paths in the first three-way valve V1 and the second three-way valve V2 enables ink or cleaning liquid to circulate to a head unit 4, thereby partial cleaning can be performed to partially clean the ink flow path when the inkjet printing apparatus 100 is in a temporarily suspended state and the use of the apparatus is stopped for a relatively short period of time. This allows focused cleaning only in the necessary areas, making it possible to reduce the consumption of cleaning liquid and ink which are liquids. Also, the time required for cleaning can be reduced. In addition, cleaning removes aggregated and settled solids in the ink, making it possible to maintain a state suitable for printing.

In the inkjet printing apparatus 100 of the present invention, the first flow path P1 makes liquid flow from the buffer tank 1 to the IN-side distribution tank 41, and the second flow path P2 makes liquid flow from the OUT-side distribution tank 43 to the buffer tank 1, this allows cleaning liquid, which is a liquid, to flow primarily to the head 42, which is a precision machine, and is a part where ink aggregates are likely to be a problem, thereby improving the cleaning effect of the ink flow paths.

The inkjet printing apparatus 100 of the present invention is further equipped with an auxiliary flow path P5, an auxiliary three-way valve V3, and an auxiliary waste liquid flow path P6, and switching the flow paths in the first three-way valve V1, the second three-way valve V2, and the auxiliary three-way valve V3, makes ink or cleaning liquid circulate to the head unit 4, which allows the ink or cleaning liquid flow from the IN-side distribution tank 41 to the buffer tank 1 or the waste liquid unit 3. When the liquid is ink, this prevents the ink from remaining in the IN-side distribution tank 41 thereby preventing solids in the ink from aggregating and settling, making it possible to maintain a state suitable for printing.

Also, when the liquid is a cleaning liquid, the IN-side distribution tank 41 can be efficiently cleaned using the more subdivided flow paths. Specifically, it becomes possible to clean the auxiliary flow path P5 between the IN-side distribution tank 41 and the auxiliary three-way valve V3 as well as the auxiliary waste liquid flow path P6 with the cleaning liquid.

The inkjet printing apparatus 100 of the present invention is further equipped with a circulation three-way valve V4 and a circulation flow path P7, and by switching the flow path in the circulation three-way valve V4, liquid is circulated from buffer tank 1 to buffer tank 1, and when the liquid is ink, the ink circulates through the circulation flow path P7, a relatively short flow path, preventing solids in the ink in buffer tank 1 from aggregating and settling, and making it possible to maintain a state suitable for printing. Also, the temperature of the ink can be easily adjusted. As a result, ink in a state suitable for printing is supplied from the buffer tank 1 to the head unit 4.

In addition, when the liquid is a cleaning liquid, the buffer tank 1 can be efficiently cleaned by circulating the cleaning liquid through a short flow path via the circulation flow path P7. Furthermore, the first flow path P1 from the buffer tank 1 to the circulation three-way valve V4 as well as the circulation flow path P7 can be cleaned. The same applies when the liquid is purified water.

Moreover, by having the circulation three-way valve V4 and the circulation flow path P7, the flow path can be configured simply because a separate flow path for waste liquid from the buffer tank 1 as well as for circulation is not necessary.

The inkjet printing apparatus 100 of the present invention is further equipped with liquid supply source 5 and a supply flow path P8, and because the liquid supply source 5 has an ink supply source 51 and a purified water supply source 52, by switching the liquid supply source 5, it is possible to circulate ink or purified water, which is a liquid, through the flow path using the same supply flow path P8 and pump P. This enables full cleaning, which cleans the entire ink flow paths, and makes it possible to prevent solids in the ink within the inkjet printing apparatus 100 from aggregating and settling when the inkjet printing apparatus 100 is stopped completely when printing is stopped for a relatively long period of time.

In the inkjet printing apparatus 100 of the present invention, because the cleaning liquid is water containing a solvent or a surfactant, areas where remaining ink is likely to be a problem, such as the head unit 4, which is a precision machine, can be thoroughly cleaned with the cleaning liquid.

On the other hand, since the purified water is water that does not contain a solvent or a surfactant, it is possible to use purified water, which is easily procured, to clean areas such as the buffer tank 1 where remained ink is relatively less likely to be a problem. Therefore, it is possible to reduce the amount of cleaning liquid used, which provides cost benefits. Also, the environmental load can be reduced.

Because the cleaning method 200 for the inkjet printing apparatus 100 of the present invention has a first cleaning process S1 and

a second cleaning process S2, when printing in the inkjet printing apparatus 100 is temporarily suspended, the ink inside the head unit 4, the area where aggregation and settling of solids in the ink are most likely to be a problem, can be replaced with cleaning liquid, making it possible to maintain print quality when printing is resumed.

Also, it becomes possible to clean the second flow path P2 from the OUT-side distribution tank 43 to the second three-way valve V2 and the waste liquid flow path P4 with cleaning liquid, and if the inkjet printing apparatus 100 is equipped with an auxiliary flow path P5 and an auxiliary waste liquid flow path P6, it becomes possible to clean the auxiliary flow path P5 from the IN-side distribution tank 41 to the third three-way valve V3 and the auxiliary waste liquid flow path P6 with cleaning liquid.

In the cleaning method 200 for the inkjet printing apparatus 100 of the present invention, when the amount of cleaning liquid stored in the buffer tank 1 reaches an upper limit, the second cleaning process S2 makes the cleaning liquid to flow from the second flow path P2 to the waste liquid flow path P4 via the second three-way valve V2, and then into the waste liquid unit 3 for discharge, thereby making it possible to clean the second flow path P2 from the second three-way valve V2 to the buffer tank 1 with the cleaning liquid. Also, when the inkjet printing apparatus 100 is equipped with the auxiliary flow path P5, the auxiliary flow path P5 from the third three-way valve V3 to the buffer tank 1 can be cleaned with the cleaning liquid.

In addition, as the cleaning liquid is to be stored in the buffer tank 1 to the same level as the ink, allowing the necessary areas to be sufficiently cleaned while suppressing excessive cleaning and reducing the amount of cleaning liquid used.

The cleaning method 200 for the inkjet printing apparatus 100 of the present invention performs full cleaning when the inkjet printing apparatus 100 is stopped for longer than a certain period of time determined arbitrarily, and performs partial cleaning when the inkjet printing apparatus 100 is stopped for less than the certain period of time, thereby making it possible to reduce the amount of cleaning liquid and ink to be replaced depending the period of stopping the inkjet printing apparatus 100. Also, when partial cleaning is performed, cleaning and printing can be resumed in a shorter time than when full cleaning is performed.

### BRIEF DESCRIPTION OF DRAWINGS

FIG. 1 is a schematic diagram showing an inkjet printing apparatus according to this embodiment.

FIG. 2 is a flowchart showing partial cleaning process.

FIG. 3 is a schematic diagram showing an inkjet printing apparatus in a state where a first flow path is connected to a waste liquid unit.

FIG. 4 is a flowchart showing the full cleaning process.

FIG. 5 is a schematic diagram showing an inkjet printing apparatus in a state where ink is being recovered from a buffer tank.

FIG. 6 is a schematic diagram showing an inkjet printing apparatus in a state where ink is replaced with purified water.

FIG. 7 is a schematic diagram showing an inkjet printing apparatus equipped with multiple IN-side distribution tanks and OUT-side distribution tanks.

### DESCRIPTION OF EMBODIMENTS

Hereinafter, preferred embodiments of the present invention are described in detail with reference to the drawings as necessary. Note that in the drawings, the same elements are given the same reference signs, and duplicated explanations are omitted. Also, unless otherwise specified, positional relationships such as top, bottom, left, and right are based on the positional relationships shown in the drawings. In addition, the dimensional ratios in the drawings are not limited to those shown in the drawings.

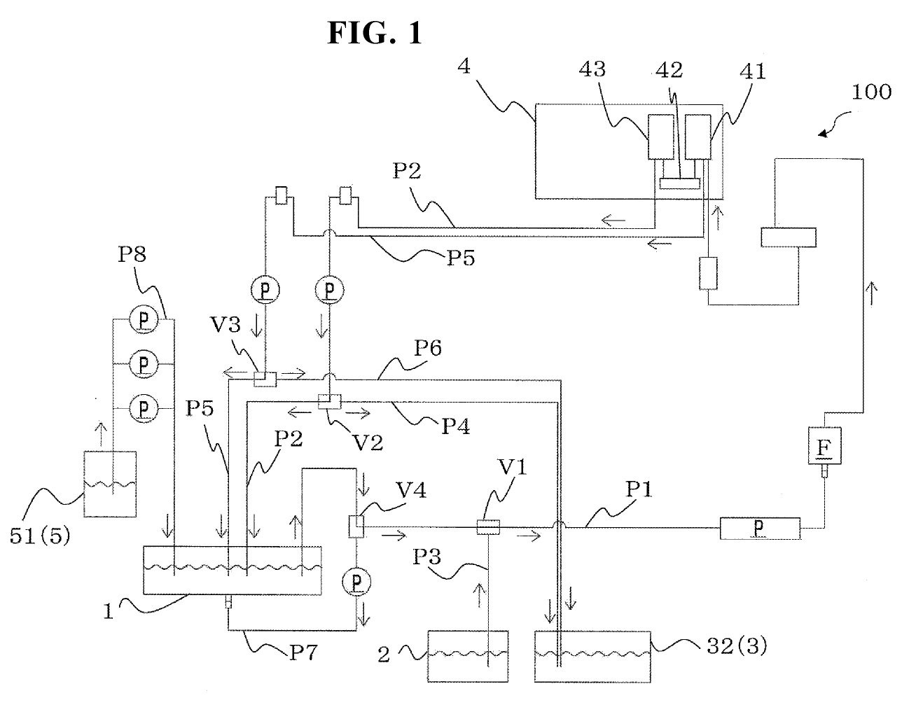

FIG. 1 is a schematic diagram showing an inkjet printing apparatus 100 according to this embodiment. Hereinafter, the arrows in the drawings indicate the flow direction of the liquid flowing through each flow path.

As shown in FIG. 1, the inkjet printing apparatus 100 according to this embodiment is a partially cleanable inkjet printing apparatus 100, and is equipped with: a buffer tank 1 for storing liquid; a head unit 4 for ejecting liquid; a cleaning liquid tank 2 for storing cleaning liquid; a waste liquid unit 3 for discharging the cleaning liquid after cleaning; and a liquid supply source 5 for supplying liquid.

Also as flow paths for ink or cleaning liquid and valves for opening and closing these flow paths, this apparatus is equipped with: a first flow path P1 which makes liquid flow from the buffer tank 1 to the head unit 4; a second flow path P2 which makes liquid flow from the head unit 4 to the buffer tank 1; a first three-way valve V1 placed in the first flow path P1; a second three-way valve V2 placed in the second flow path P2;a cleaning liquid flow path P3 connected to the first three-way valve V1 and makes the cleaning liquid flow from the cleaning liquid tank 2 to the first three-way valve V1; a waste liquid flow path P4 connected to the second three-way valve V2 and makes the liquid flow from the second three-way valve V2 to the waste liquid unit 3; an auxiliary flow path P5 which makes liquid flow from IN-side distribution tank 41 to buffer tank 1; an auxiliary three-way valve V3 placed in the auxiliary flow path P5; an auxiliary waste liquid flow path P6 connected to the auxiliary three-way valve V3 and makes liquid flow from the said auxiliary three-way valve V3 to the waste liquid unit 3; a circulation three-way valve V4 placed upstream of the first three-way valve V1 in the first flow path P1; a circulation flow path P7 connected to the said circulation three-way valve V4 and makes ink flow from the said circulation three-way valve V4 to the buffer tank 1; and a supply flow path P8 which makes liquid flow from the liquid supply source 5 to the buffer tank 1.

Here, the liquid circulating through the inkjet printing apparatus 100 is ink, cleaning liquid, or purified water. When printing is performed using the inkjet printing apparatus 100, ink circulates through the inkjet printing apparatus 100, and when cleaning the inkjet printing apparatus 100, cleaning liquid or purified water circulates through the inkjet printing apparatus 100.

The inkjet printing apparatus 100 performs printing by ejecting ink from a head unit 4 on a print medium not shown in the drawings.

Here, the ink used is not particularly limited, and any commercially available ink can be used as appropriate. Specifically, for example, an ink containing a colorant such as a dye or pigment, an aqueous solvent, and publicly known additives that are added as needed is used.

Also, print medium used is not particularly limited, and any commercially available one can be used as appropriate. Specifically, for example, paper, fabric, nonwoven fabric, film, metal foil, and the like can be used. In addition, these media may have an ink-receiving layer for receiving ink placed on the surface on which the ink is applied.

The print medium on which the ink has been applied is dried, for example, by a drying device not shown in the drawings, and then, recovered.

Ink is supplied to the buffer tank 1 from an ink supply source 51 which is an ink tank of the liquid supply source 5. The liquid supply source 5 and the buffer tank 1 are connected by a supply flow path P8 in which a pump P is placed and by driving the pump P, ink is supplied from the ink supply source 51 to the buffer tank 1 via the supply flow path P8. By the way, regarding the fact that liquid in the flow path is circulated by the pump P placed in the flow path, the same applies to the other flow paths.

The end of the supply flow path P8 on the liquid supply source 5 side is freely removed from and inserted into the liquid supply source 5. This allows the end to be removed from the ink supply source 51 and inserted to the purified water supply source 52 as described later, and makes it possible to supply purified water to the buffer tank 1 instead of ink.

For the ink supply source 51 and the purified water supply source 52, any suitable structure capable of holding liquid, such as a polyethylene tank or a 18-litter can may be used.

In this Description, publicly known tubes and the like are appropriately used as the members of each flow path. These members may be the same or different from each other.

The ink in the buffer tank 1 flows out of the buffer tank 1 to the first three-way valve V1 side via the circulation three-way valve V4.

The circulation three-way valve V4 is used to branch the liquid flowing out of the buffer tank 1 in two directions. One flows to the first three-way valve V1 side as described above, and the other circulates to the buffer tank 1. Here, the flow path that makes ink flow from the buffer tank 1 to the head unit 4 via the first three-way valve V1 side as described later is referred to as a first flow path P1. Also, the flow path from the circulation three-way valve V4 to the buffer tank 1 is referred to as circulation flow path P7.

The ink in the buffer tank 1 is prevented from remaining stationary by circulating via the circulation three-way valve V4 and the circulation flow path P7. This makes it possible to suppress changes in ink temperature, aggregation and settling of solids in the ink, and also to adjust the ink temperature efficiently. As a result, ink in a state suitable for printing is able to flow to the head unit 4 via the first flow path P1.

In the inkjet printing apparatus 100, by equipping with the circulation three-way valve V4 and the circulation flow path P7, the flow path can be configured simply because a separate flow path for waste liquid from the buffer tank 1 as well as for circulation is not necessary.

Inside the buffer tank 1, a sensor for detecting the liquid level in the buffer tank 1 is placed. As for a sensor, a float switch is suitably used.

The float switch is capable of detecting three liquid levels: the upper limit position, the appropriate position, and the lower limit position. In the buffer tank 1, ink flows in or out depending on the ink level detected by the float switch.

The end of the circulation flow path P7 and the buffer tank 1 are connected so as to be freely attached and detached via a connector. This makes it possible to connect the circulation flow path P7 and the buffer tank 1 to the waste liquid unit 3, as described later.

As for a connector, coupler can be suitably used.

The cleaning liquid tank 2 is a container for storing the cleaning liquid, and contains the cleaning liquid. The cleaning liquid tank 2 is not used by the inkjet printing apparatus 100 during printing, but is used when cleaning the inkjet printing apparatus 100 described later.

The cleaning liquid is a liquid containing a solvent or a surfactant. This makes it possible for areas where remained ink is likely to be a problem, such as the head unit 4, which is a precision machine, thoroughly cleaned.

The first flow path P1 on the downstream side of the first three-way valve V1 is equipped with, from the upstream side, an ink filter F, a heat exchanger, and a degassing membrane module. These remove foreign matters from the ink flowing through the first flow path P1 and also regulate the temperature of the ink. These improve the ink condition, thereby improving print quality.

Also, the upstream side of the ink filter F is connected so as to be freely attached and detached via a connector. This allows the end of the flow path to be connected to the waste liquid unit 3. Therefore, as described later, when cleaning flow paths, by attaching or detaching the connector, the liquid that has flowed to the first flow path P1 can be diverted to the waste liquid unit 3 rather than to the head unit 4.

Here, the waste liquid unit 3 is a container for storing liquid to be disposed of, such as used ink and cleaning liquid, when cleaning the inkjet printing apparatus 100.

The waste liquid unit 3 is composed of a recovery container 31 for storing and recovering reusable ink, and a waste liquid container 32 for storing waste liquid.

The recovery container 31 and the waste liquid container 32 may be any suitable containers capable of storing liquid. In particular, using empty containers such as containers of the same color ink can reduce the environmental load.

The end of the first flow path P1 is connected to the head unit 4.

The head unit 4 has an IN-side distribution tank 41, a head 42 into which ink flows from the said IN-side distribution tank 41, and an OUT-side distribution tank 43 from which ink flows out from the said head 42, and all are housed in a head box.

As mentioned earlier, the head 42 ejects ink toward a print medium to perform printing, and ink that is not ejected from the head 42 flows into the OUT-side distribution tank 43.

The head 42 may be of any publicly known configuration, and in this embodiment, a line head is used.

A solenoid valve is placed on the head 42 side of each of the IN-side distribution tank 41 and the OUT-side distribution tank 43, and each of these solenoid valves can open and close the flow path. Also, the IN-side distribution tank 41 and the OUT-side distribution tank 43 are each equipped with a pressure adjustment mechanism, making it possible to control the internal pressure of the IN-side distribution tank 41 and the OUT-side distribution tank 43.

By controlling the solenoid valve and the pressure adjustment mechanism through a control unit, which is not shown in the drawings, ink is supplied from the IN-side distribution tank 41 to the head 42 and the OUT-side distribution tank 43.

As for a pressure adjustment mechanism, a compressor, a vacuum pump, a tube pump, a diaphragm pump, or the like may be appropriately used.

In the inkjet printing apparatus 100, the pressure adjustment mechanism makes the pressure in the IN-side distribution tank 41 higher than the pressure in the OUT-side distribution tank 43, so that ink flows from the IN-side distribution tank 41 to the head 42 and from the head 42 to the OUT-side distribution tank 43.

The IN-side distribution tank 41 and the OUT-side distribution tank 43 are equipped with sensors for detecting liquid levels inside of the tanks. As for a sensor, a float switch is suitably used.

The float switch is capable of detecting three liquid levels: the upper limit position, the appropriate position, and the lower limit position.

In the IN-side distribution tank 41 and the OUT-side distribution tank 43, ink flows in or out depending on the ink levels detected by the float switch.

The IN-side distribution tank 41 is equipped with an auxiliary flow path P5 for making ink flow from the IN-side distribution tank 41 to the buffer tank 1. The auxiliary flow path P5 is equipped with an auxiliary three-way valve V3, which makes it possible to switch the flow path for the liquid circulating through the auxiliary flow path P5. One side of the auxiliary three-way valve V3 is connected to the buffer tank 1 as described above, and the other side is connected to the waste liquid unit 3 via the auxiliary waste liquid flow path P6.

The auxiliary flow path P5 allows ink to circulate between the IN-side distribution tank 41 and the buffer tank 1. This makes it possible to suppress aggregation and settling of solids in the ink in the IN-side distribution tank 41 even when printing is temporarily stopped, making it possible to maintain ink in a suitable state for printing.

The OUT-side distribution tank 43 is equipped with a second flow path P2 for making ink flow from the OUT-side distribution tank 43 to the buffer tank 1. Also, a second three-way valve V2 is placed in the second flow path P2, which makes it possible to switch the flow path of the liquid flowing through the second flow path P2. One side of the second three-way valve V2 is connected to the buffer tank 1 as described above, and the other side is connected to the waste liquid unit 3 via the auxiliary waste liquid flow path P4.

The second flow path P2 allows the ink that is not ejected by the head 42 and recovered in the OUT-side distribution tank 43 to be circulated between the OUT-side distribution tank 43 and the buffer tank 1. This makes it possible to suppress aggregation and settling of solids in the ink.

In the second flow path P2 and the auxiliary flow path P5, valves are placed to prevent liquid from dripping. By closing these valves as necessary, the solenoid valve or pressure adjustment mechanism in the head unit 4 is driven, and liquid flows from the IN-side distribution tank 41 or the OUT-side distribution tank 43 to the buffer tank 1 by gravity without driving the pump P, preventing changes in the amount of liquid in the IN-side distribution tank 41 and the OUT-side distribution tank 43. This makes it possible to prevent errors when the inkjet printing apparatus 100 is driven.

During printing, in the inkjet printing apparatus 100, ink is filled in individual flow paths and components mentioned above and is in a state to circulates.

Hereunder, the cleaning method 200 for the inkjet printing apparatus 100 of the present invention is described.

As mentioned above, in the inkjet printing apparatus 100 during printing, the ink is driven by the pump P and is in a state to circulates. Therefore, if printing is stopped for a relatively short period of time, the circulation of the ink suppresses aggregation and settling of solids in the ink, and printing can be stopped and resumed without any problems.

On the other hand, if printing is stopped for a long period of time, for example, four days or longer, as it is not possible to completely prevent aggregation and settling of solids in the ink, removing the ink from the inkjet printing apparatus and cleaning are necessary.

When cleaning is performed, first, the pumps P placed in each flow path except for the circulation flow path P7 are stopped to stop the circulation of ink.

### Partial cleaning

If printing is stopped for 4 days or longer but less than 11 days, it is better for the head unit 4, which is most likely to have aggregation and settling problems of solids in the ink, to be cleaned. On the other hand, since the buffer tank 1, which stores a large amount of ink, is circulated through a relatively short flow path via the circulation flow path P7, the ink condition is easily maintained, and it is not quite necessary to have it cleaned and to have the ink and cleaning liquid replaced. Furthermore, cleaning the buffer tank 1 which stores a large amount of ink increases the amount of ink to be disposed of, and also requires a large amount of cleaning liquid.

Therefore, it is preferable to perform partial cleaning, excluding the area containing the buffer tank 1 from the ink flow path. Stopping of the inkjet printing apparatus 100 for a relatively short period of time for partial cleaning is referred to a temporarily suspended state.

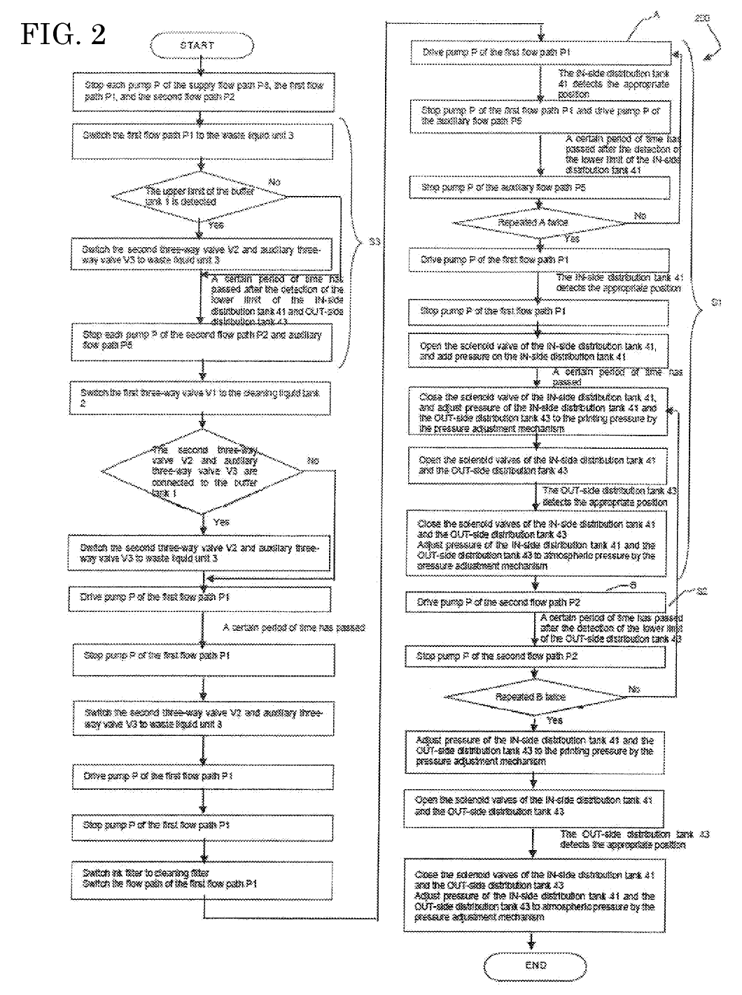

FIG. 2 is a flowchart showing partial cleaning process. In the flowchart, A and B are signs indicating processes that are repeated.

In the partial cleaning, cleaning liquid is circulated through the head unit 4 to replace the ink with the cleaning liquid.

More specifically, in the first cleaning process S1, the first three-way valve V1 makes the cleaning liquid in the cleaning liquid tank 2 flow from the cleaning liquid flow path P3 to the first flow path P1 and circulate through the head unit 4, thereby cleaning the said head unit 4.

In the subsequent second cleaning process S2, the cleaning liquid that has circulated to the head unit 4 flows from the said head unit 4 to the second flow path P2, and the second three-way valve V2 makes the cleaning liquid flow from the second flow path P2 to the waste liquid flow path P4, and then into the waste liquid unit 3 for discharge, and at the same time, the auxiliary three-way valve V3 makes the cleaning liquid flow from the auxiliary flow path P5 to the auxiliary waste liquid flow path P6, and then into the waste liquid unit 3 for discharge.

### Partial cleaning preparation process S3

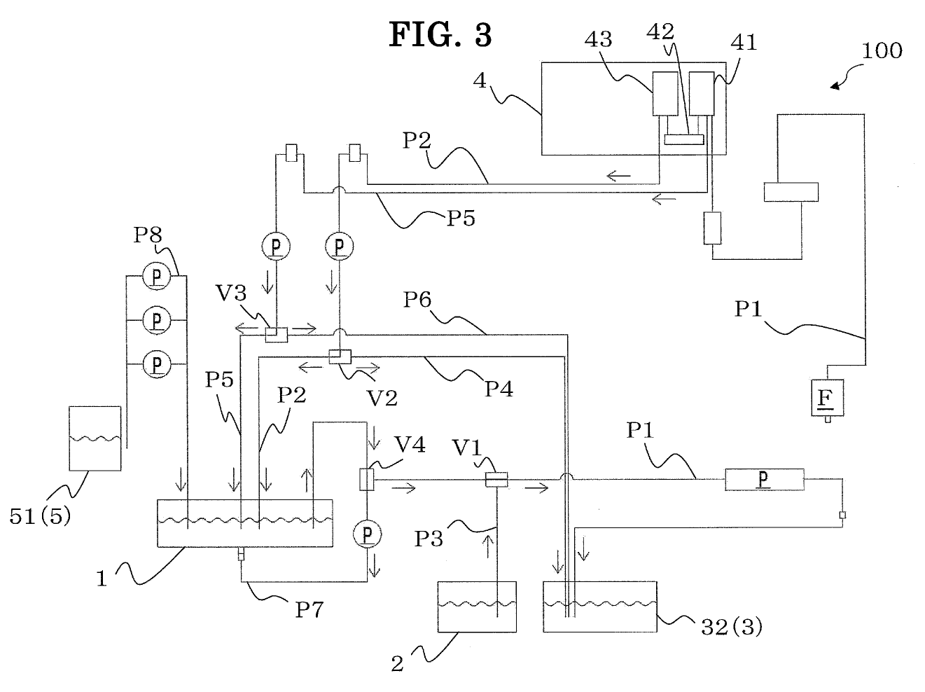

FIG. 3 is a schematic diagram showing the inkjet printing apparatus 100 in a state where the first flow path P1 is connected to the waste liquid unit 3.

First, the connector that is connected to the ink filter F of the first flow path P1 is removed and connected to the waste liquid unit 3. This makes the ink that has flowed to the first flow path P1 flow out into the waste liquid unit 3. More specifically, at this time, the connector of the first flow path P1 is connected to the waste liquid container 32 of the waste liquid unit 3.

Next, the pumps P attached to the second flow path P2 and the auxiliary flow path P5 are driven respectively. This makes the ink in the IN-side distribution tank 41 and the OUT-side distribution tank 43 flow into the buffer tank 1.

When the sensor in the buffer tank 1 detects the upper limit of the ink level in the buffer tank 1, the second three-way valve V2 is switched to the waste liquid flow path P4, and the auxiliary three-way valve V3 is switched to the auxiliary waste liquid flow path P6. As a result, the ink flowing through the second flow path P2 and the auxiliary flow path P5 flows into the waste liquid unit 3.

After a certain period of time of the detection of the lowest limit position of the ink liquid levels by sensors in the IN-side distribution tank 41 and the OUT-side distribution tank 43 respectively, the pumps P attached to the second flow path P2 and the auxiliary flow path P5 are stopped respectively. The certain period of time until stopping pumps can be set appropriately. Specifically, in the case of an inkjet printing apparatus 100 whose pump flow rate for circulating ink is 100 to 1000 ml/min, about 30 to 300 seconds is preferable.

As a result, the outflow of ink from the IN-side distribution tank 41 and the OUT-side distribution tank 43 stops.

Next, the first three-way valve V1 is switched to the cleaning liquid flow path P3 side. And when the second three-way valve V2 and the auxiliary three-way valve V3 are connected to the buffer tank 1, they are switched to the waste liquid flow path P4 side and the auxiliary waste liquid flow path P6 side, respectively.

As a result, the cleaning liquid tank 2, a part of the first flow path P1 from the first three-way valve V1 to the connector connecting to the ink filter F, and the waste liquid unit 3 are connected.

And then, the pump P placed in the first flow path P1 is driven. This makes the cleaning liquid flow through a part of the first flow path P1 and cleans first flow path P1, and the contaminated cleaning liquid is recovered in the waste liquid container 32.

After a certain period of time has elapsed, the pump P placed in the first flow path P1 is stopped. The certain period of time until stopping the pump can be set appropriately, and in the example of the inkjet printing apparatus 100 mentioned above, it is preferably about 10 to 300 seconds.

Next, the ink filter F is replaced with a cleaning filter, and the connector at the end of the first flow path P1 is connected to the cleaning filter. As a result, the cleaning liquid tank 2 and the head unit 4 are connected via the first flow path P1.

The cleaning filter is a filter for removing foreign matters contained in the cleaning liquid from the ink flow path and preventing damage to the ink flow path, particularly to the head unit 4.

### First cleaning process S1

And then, the pump P placed in the first flow path P1 is driven. This makes the cleaning liquid flow into the IN-side distribution tank 41 via the first flow path P1.

When the sensor in the IN-side distribution tank 41 detects the appropriate position of the cleaning liquid level, the pump P placed in the first flow path P1 is stopped, and the pump P placed in the auxiliary flow path P5 is driven.

This makes the cleaning liquid in the IN-side distribution tank 41 be discharged into the waste liquid unit 3 via the auxiliary flow path P5, the auxiliary three-way valve V3, and the auxiliary waste liquid flow path P6.

After a certain period of time has elapsed since the detection of the lowest limit position of the cleaning liquid level by sensor in the IN-side distribution tank 41, the pump P placed in the first flow path P1 is stopped. The certain period of time until stopping the pump can be set appropriately, and in the example of the inkjet printing apparatus 100 mentioned above, it is preferably about 10 to 300 seconds.

It is preferable that the flowing of the cleaning liquid to the IN-side distribution tank 41 and the discharging of the cleaning liquid from the IN-side distribution tank 41 are repeated an appropriate number of times. In the example of the flowchart in FIG. 2, these are repeated two times (A is performed twice).

This makes it possible to sufficiently clean the IN-side distribution tank 41, the auxiliary flow path P5, and the auxiliary waste liquid flow path P6.

Next, the pump P placed in the first flow path P1 is driven again. When the sensor in the IN-side distribution tank 41 detects the appropriate position of the cleaning liquid level, the pump P placed in the first flow path P1 is stopped. As a result, the cleaning liquid is stored in the IN-side distribution tank 41.

Then, the solenoid valve of the IN-side distribution tank 41 is opened, and by adding pressure on the IN-side distribution tank 41 using the pressure adjustment mechanism, the cleaning liquid is ejected from the head 42.

This cleans the head 42. At this time, it is preferable to place a sheet or the like at the location where the printing medium is placed to receive the cleaning liquid ejected from the head 42.

Then, the solenoid valve of the IN-side distribution tank 41 is closed, and the pressure adjustment mechanisms of the IN-side distribution tank 41 and the OUT-side distribution tank 43 are used to adjust the pressure inside the IN-side distribution tank 41 and the OUT-side distribution tank 43 to the same as during printing, and the solenoid valves of the IN-side distribution tank 41 and the OUT-side distribution tank 43 are opened.

This makes the cleaning liquid that has not been ejected from the head 42 flow into the OUT-side distribution tank 43.

At this time, the pump P placed in the first flow path P1 is controlled in the same manner as during printing, and cleaning liquid is supplied to the IN-side distribution tank 41 via the first flow path P1 so that the liquid level of the cleaning liquid detected by the sensor in the IN-side distribution tank 41 is maintained at an appropriate position.

When a sufficient amount of cleaning liquid is supplied to the OUT-side distribution tank 43 and the sensor in the OUT-side distribution tank 43 detects the appropriate position of the cleaning liquid level, the solenoid valves in the IN-side distribution tank 41 and the OUT-side distribution tank 43 are closed, and the pressure adjustment mechanisms make the pressure inside the IN-side distribution tank 41 and the OUT-side distribution tank 43 atmospheric pressure. This stops the ejection of the cleaning liquid from the head 42 and the supply of the cleaning liquid to the IN-side distribution tank 41 and the OUT-side distribution tank 43.

### Second cleaning process S2

In the second cleaning process S2, the pump P placed in the second flow path P2 is driven to make the cleaning liquid in the OUT-side distribution tank 43 flow to the second flow path P2. At this time, the second three-way valve V2 has been switched to the waste liquid flow path P4 side as mentioned above, and the cleaning liquid is discharged into the waste liquid unit 3 via the waste liquid flow path P4.

After a certain period of time has elapsed since the detection of the lowest limit position of the cleaning liquid level by sensor in the OUT-side distribution tank 43, the pump P placed in the second flow path P2 is stopped. The certain period of time until stopping the pump can be set appropriately, and in the example of the inkjet printing apparatus 100 mentioned above, it is preferably about 10 to 300 seconds.

At this time, as the solenoid valves of the IN-side distribution tank 41 and the OUT-side distribution tank 43 are closed, cleaning liquid is not supplied from the IN-side distribution tank 41 to the OUT-side distribution tank 43, and the IN-side distribution tank 41 is in a state where cleaning liquid is stored.

The first cleaning process S1, in which the cleaning liquid flows through the head unit 4 after cleaning the first flow path P1, and the second cleaning process S2 mentioned above may be repeated any number of times. In the example of the flowchart in FIG. 2, these are repeated two times (B is performed twice). This makes the head unit 4 to be thoroughly cleaned.

After the head unit 4 is sufficiently cleaned, the pressure adjustment mechanisms of the IN-side distribution tank 41 and the OUT-side distribution tank 43 are used to make the pressure inside the IN-side distribution tank 41 and the OUT-side distribution tank 43 to be the pressure required during printing, and the solenoid valves of the IN-side distribution tank 41 and the OUT-side distribution tank 43 are opened. This makes the OUT-side distribution tank 43 be filled with the cleaning liquid.

Then, after the cleaning liquid is ejected from the head 42, the solenoid valves of the IN-side distribution tank 41 and the OUT-side distribution tank 43 are closed. Also, the pressure adjustment mechanisms of the IN-side distribution tank 41 and the OUT-side distribution tank 43 make the interiors of the IN-side distribution tank 41 and the OUT-side distribution tank 43 atmospheric pressure.

This makes it possible to reduce the load on the IN-side distribution tank 41 and the OUT-side distribution tank 43 while the inkjet printing apparatus 100 is stopped.

Then, by treating the head unit 4 such as wiping, the inkjet printing apparatus 100 becomes in a state suitable for stopping.

### Resuming printing after partial cleaning

When resuming the printing of the inkjet printing apparatus 100 after partial cleaning, it is necessary to replace filled cleaning liquid with ink.

In this case, using the same procedure with the above, the cleaning liquid filled into the flow path and the mixed liquid of ink and cleaning liquid produced during the replacement operation are discharged into the waste liquid container 32, and ink is filled into the first flow path P1, the head unit 4, the second flow path P2 from the head unit 4 to the second three-way valve V2, and the auxiliary flow path P5 from the head unit 4 to the auxiliary three-way valve V3. At this time, by using the ink recovered in the buffer tank 1, it is possible to suppress ink loss and reduce the environmental load.

By performing partial cleaning, the buffer tank 1 in which a large amount of ink is stored remains in a state in which ink is stored even after cleaning. Therefore, the amounts of ink and cleaning liquid to be replaced can be reduced, thereby suppressing ink loss. It is also possible to reduce the time required for cleaning when printing is stopped as well as for filling ink when printing is resumed.

On the other hand, this allows focused cleaning only in the necessary areas such as the head unit 4, making it possible to maintain a state suitable for printing.

### Full cleaning

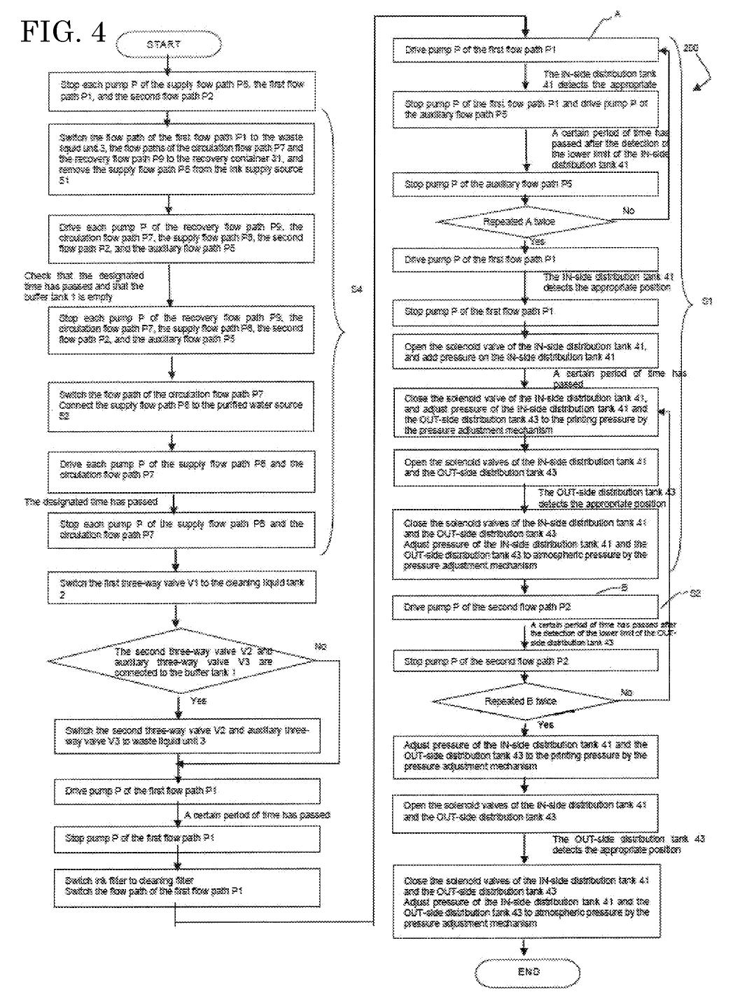

FIG. 4 is a flowchart showing the full cleaning process. In the flowchart, A and B are signs indicating processes that are repeated.

If printing is stopped completely for 11 days or longer, it is preferable to perform a full cleaning in which the entire flow paths including the buffer tank 1 is cleaned.

When performing full cleaning, similar to the case of partial cleaning, the pumps P placed in the individual flow paths are stopped to stop the circulation of ink.

### Full cleaning preparation process S4

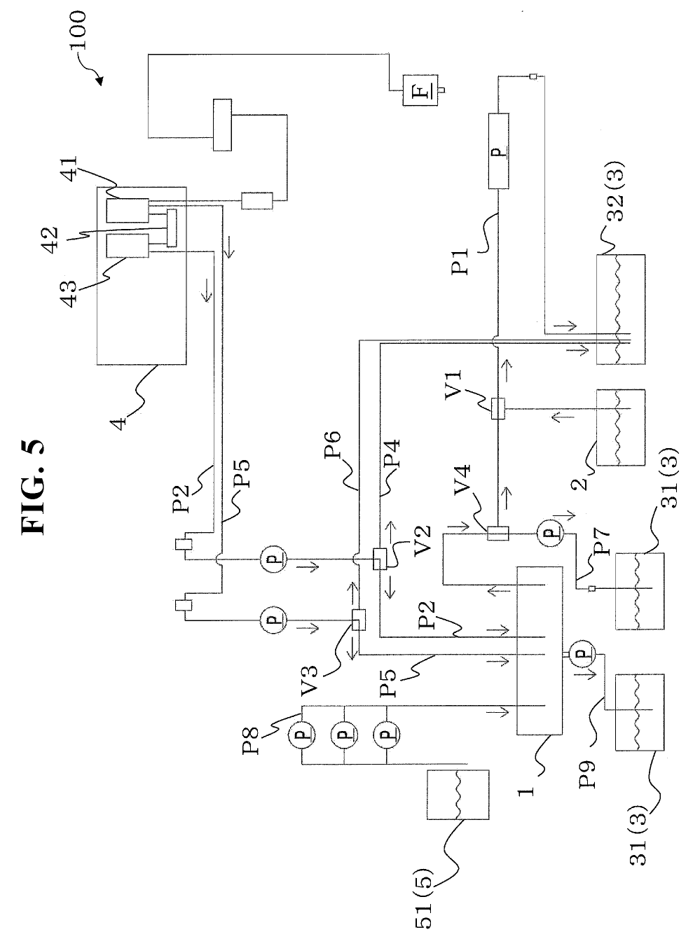

FIG. 5 is a schematic diagram showing an inkjet printing apparatus 100 in a state where ink is being recovered from a buffer tank 1.

First, as shown in FIG. 5, the connector that is connected to the ink filter F of the first flow path P1 is removed and connected to the waste liquid unit 32. Also, the connector for circulating the liquid to the buffer tank 1 of the circulation flow path P7 is removed and connected to the recovery container 31.

In addition, the supply flow path P8 connected to the ink supply source 51 is removed from the ink supply source 51.

As shown in FIG. 5, to the buffer tank 1 connector to which the circulation flow path P7 was connected, a recovery flow path P9 is connected by another connector. The other end of the recovery flow path P9 is connected to the recovery container 31.

In the example of FIG. 5, there are multiple recovery containers 31, but there may be only one.

Next, the pump P attached to the recovery flow path P 9 is driven to recover the ink in the buffer tank 1 into the recovery container 31.

At the same time, the pump P attached to the circulation flow path P 7 is driven to recover the ink in the buffer tank 1 into the recovery container 31.

Furthermore, the pump P attached to the supply flow path P8 is driven concurrently to make the ink in the supply flow path P8 flow out into the buffer tank 1. This driving time in the example of the inkjet printing apparatus 100 mentioned above is preferably about 10 to 300 seconds.

After a certain period of time has elapsed since the ink recovery from the buffer tank 1 to each recovery container 31 mentioned above has started, the pump P attached to the auxiliary flow path P5 is driven, making the ink in the IN side distribution tank 41 flow out into the buffer tank 1 via the auxiliary flow path P5, and then, recovered in each recovery container 31 via each of the above flow paths.

The certain period of time after which the recovery of the ink in the IN-side distribution tank 41 is started, in the example of the inkjet printing apparatus 100 mentioned above, is preferably about 1 to 30 minutes.

When the sensor in the IN-side distribution tank 41 detects the lower limit position of the ink level, the pump P attached to the auxiliary flow path P5 is stopped after a certain period of time since the detection. This, in the example of the inkjet printing apparatus 100 mentioned above, is preferably about 10 to 300 seconds after the detection.

At the time when the ink is recovered in the IN-side distribution tank 41, the pump P attached to the second flow path P2 is driven simultaneously, making the ink in the OUT-side distribution tank 43 flow out into the buffer tank 1 via the second flow path P2, and then, recovered in each recovery container 31 via each of the above flow paths.

When the sensor in the OUT-side distribution tank 43 detects the lower limit position of the ink level, the pump P attached to the second flow path P2 is stopped after a certain period of time since the detection. This, in the example of the inkjet printing apparatus 100 mentioned above, is preferably about 10 to 300 seconds after the detection.

Once all the ink in the buffer tank 1 is recovered, the pump P of the circulation flow path P7 is driven for a few seconds to recover the ink in the circulation flow path P7 into the recovery container 31, and then the connector at the downstream end of the circulation flow path P7 is connected to the buffer tank 1.

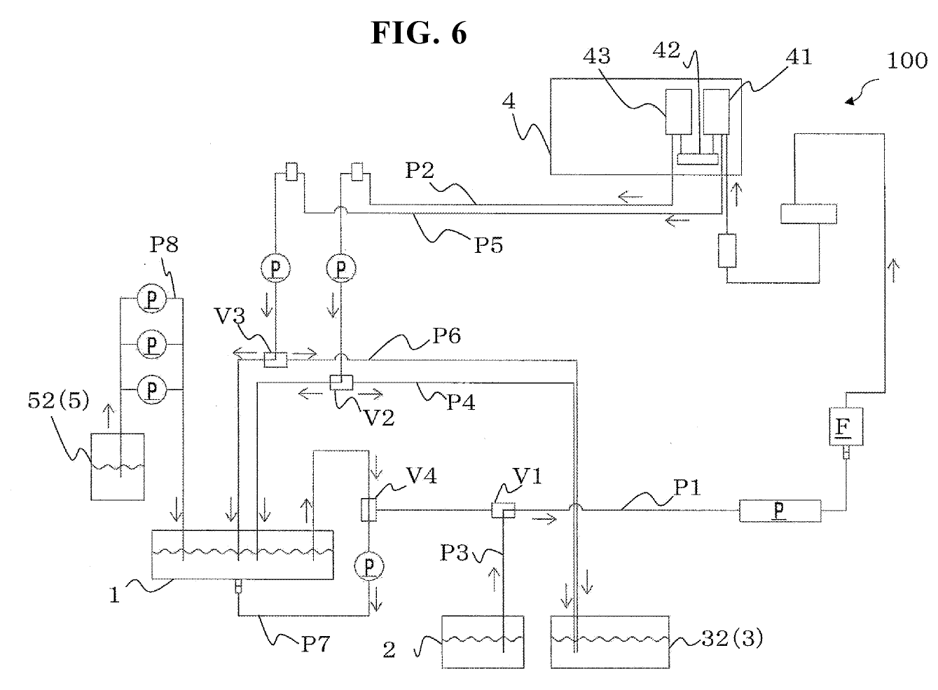

Also, the end of the supply flow path P8 is connected to the purified water supply source 52 of the liquid supply source 5 (see FIG. 6).

The pump P attached to the supply flow path P8 is driven to supply purified water to the buffer tank 1.

Once purified water is stored in the buffer tank 1, the pump P attached to the circulation flow path P7 is driven to clean a part of the first flow path P1 up to the circulation three-way valve V4 and the circulation flow path P7 with purified water. This, in the example of the inkjet printing apparatus 100 mentioned above, is preferably about 2 to 6 minutes, and more preferably about 4 minutes, after around 70% of the stored amount of purified water to be supplied has been supplied to the buffer tank 1.

The amount of purified water stored in the buffer tank 1 is preferably around 90% of the capacity (equivalent to one pack of purified water) where the float in buffer tank 1 is in the correct position.

As a result, the supply flow path P8, the buffer tank 1, a part of the first flow path P1 up to the circulation three-way valve V4, and the circulation flow path P7 are cleaned, and the ink is replaced with purified water.

The flow path from the buffer tank 1 via the circulation flow path P7 is shorter than the other flow paths. By circulating purified water through this short flow path, the buffer tank 1 can be cleaned efficiently.

Purified water is water that does not contain a solvent or a surfactant, and pure water, distilled water, and the like are suitably used. This makes it possible to use purified water, which is easily procured, to clean areas such as the buffer tank 1, where ink is relatively less likely to remain, thereby, the amount of cleaning liquid used can be reduced. Accordingly, cost benefits are gained, and also, environmental load can be reduced.

After the ink in the buffer tank 1 is replaced with purified water, the head unit 4 is cleaned by performing the first cleaning process S1 and the second cleaning process S2 similar to the partial cleaning mentioned above, and the first flow path P1, the head unit 4, the second flow path P2, and the auxiliary flow path P5 are filled with cleaning liquid.

FIG. 6 is a schematic diagram showing the inkjet printing apparatus 100 in a state where the ink has been replaced with purified water, and shows the state in the process of performing the first cleaning process S1 in the full cleaning.

The difference from the partial cleaning is that the cleaning liquid discharged from the head unit 4 in the second cleaning process S2 flows into the buffer tank 1 via the second flow path P2 and the auxiliary flow path P5. As a result, purified water and cleaning liquid are mixed and stored in the buffer tank 1.

When the amount of the mixture of purified water and cleaning liquid stored in the buffer tank 1 reaches the upper limit, the cleaning liquid is made to flow from the OUT-side distribution tank 43 to the second flow path P2 via the second three-way valve V2, and to the waste liquid flow path P4, and then into the waste liquid unit 3 for discharge. The discharged cleaning liquid is stored in a waste liquid container 32 and then discharged.

This allows the second flow path P2 from the second three-way valve V2 to the buffer tank 1 to be cleaned with the cleaning liquid. In addition, as the cleaning liquid is to be stored in the buffer tank 1 to the same level as the ink, allowing the necessary areas to be sufficiently cleaned while suppressing excessive cleaning and reducing the amount of cleaning liquid used.

Note that, if the amount of cleaning liquid stored in the buffer tank 1 does not reach the upper limit, the inkjet printing apparatus 100 stops completely, and when the power is turned off, the second three-way valve V2 is switched from the buffer tank 1 side to the waste liquid flow path P4 side.

As a result, all of the ink in the inkjet printing apparatus 100 is replaced with purified water or cleaning liquid, and the apparatus can be brought into a state suitable for long-term stopping for printing.

### Resuming printing after full cleaning

When printing is resumed in the inkjet printing apparatus 100 after the full cleaning, the purified water or cleaning liquid is replaced with ink in the same manner as the above. At this time, by using the ink collected in the recovery container 31, it is possible to suppress ink loss and reduce the environmental load.

Also, the cleaning liquid, purified water, as well as a mixture of these with ink that is generated during the ink replacement operation are discharged into a waste liquid container 32 instead of the recovery container 31.

That concludes the explanation of the preferred embodiments of the present invention; however, the present invention is not limited to the above embodiments.

In this embodiment, the certain period of time that serves as the criteria for the temporarily stopped state and the completely stopped state are 4 days and 11 days, respectively, however, these can be set arbitrarily.

The driving and stopping of each P, the switching of the first three-way valve V1, the second three-way valve V2, the auxiliary three-way valve V3 and the circulation three-way valve V4, the opening and closing of the solenoid valve in the head unit 4, and the control of the pressure adjustment mechanism mentioned above may be performed automatically by a control unit not shown in the drawings.

A computer and the like can be suitably used as the control unit.

In this embodiment, one pump P is placed for each flow path, but multiple pumps P may be placed, such as for the supply flow path P8. For example, the flow path may be branched into multiple parallel paths, each of which may have a pump P. In this case, the load on each pump P can be reduced, and a pump P with a low output can be used. Also, even if one of the pumps P breaks down, the flow of ink and cleaning liquid will not be interrupted.

On the other hand, the supply flow path P8 may be configured with a single flow path and a pump P. In this case, the number of parts can be reduced.

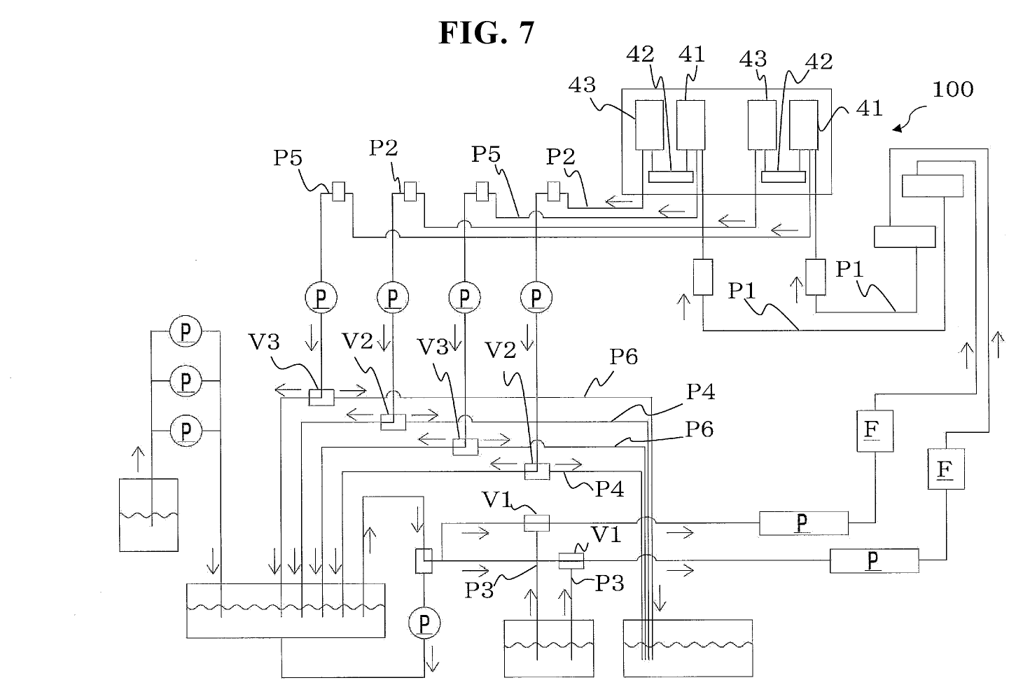

FIG. 7 is a schematic diagram showing an inkjet printing apparatus 100 equipped with multiple IN-side distribution tanks 41 and OUT-side distribution tanks 43.

In this embodiment, in FIG. 1, one each of the IN-side distribution tank 41, the head 42, and the OUT-side distribution tank 43 is shown, however, there may be multiple of each of these.

In this case, as shown in FIG. 7, each of the IN-side distribution tanks 41 is equipped with an auxiliary flow path P5, and each of the OUT-side distribution tanks 43 is equipped with a second flow path P2. At this time, a second three-way valve V2 is placed in each of the second flow paths P2, and an auxiliary three-way valve V3 is placed in each of the auxiliary flow paths P5, making it possible to circulate cleaning liquid to clean the inkjet printing apparatus 100 in the same manner as mentioned above.

Heat sensors for measuring the temperature of ink may be placed at appropriate locations such as the buffer tank 1, the IN-side distribution tank 41, and the OUT-side distribution tank 43. A thermocouple can be suitably used as the heat sensor.

By placing heat sensors, it is possible to properly manage the temperature of the ink circulating within the inkjet printing apparatus 100, which makes it possible to improve the printing quality.

### Industrial Applicability

The inkjet printing apparatus 100 of the present invention can be widely used in inkjet printing apparatuses where printing is stopped for a certain period of time.

Also, the cleaning method 200 for the inkjet printing apparatus 100 of the present invention can reduce the amounts of ink and cleaning liquid used depending on the length of the period during which printing is stopped.

### REFERENCE SIGNS LIST

100...Inkjet printing apparatus
1...Buffer tank
2...Cleaning liquid tank
3...Waste liquid unit
31...Recovery container
32...Waste liquid container
4...Head unit
41...IN-side distribution tank
42...Head
43...OUT-side distribution tank
5...Liquid supply source
51...Ink supply source
52...Purified water supply source
V1...First three-way valve
V2...Second three-way valve
V3...Auxiliary three-way valve
V4...Circulation three-way valve
P1...First flow path
P2...Second flow path
P3...Cleaning liquid flow path
P4...Waste liquid flow path
P5...Auxiliary flow path
P6...Auxiliary waste liquid flow path
P7...Circulation flow path
P8...Supply flow path
P9...Recovery flow path
200...Cleaning method of inkjet printing apparatus
S1...First cleaning process
S2...Second cleaning process
S3...Partial cleaning preparation process
S4...Full cleaning preparation process
P...Pump
F...Ink filter

1. An inkjet printing apparatus is a partially cleanable inkjet printing apparatus whose liquid flow paths can be cleaned partially, and
is equipped with: a buffer tank for storing the above-mentioned liquid;
a head unit for ejecting the above-mentioned liquid;
a first flow path that makes above-mentioned liquid flow from the above-mentioned buffer tank to the above-mentioned head unit;
a second flow path that makes the above-mentioned liquid flow from the above-mentioned head unit to the above-mentioned buffer tank;
a cleaning liquid tank for storing cleaning liquid;
a waste liquid unit for discharging the above-mentioned cleaning liquid after cleaning;
a first three-way valve placed in the above-mentioned first flow path;
a second three-way valve placed in the above-mentioned second flow path;
a cleaning liquid flow path connected to the above-mentioned first three-way valve and makes the above-mentioned cleaning liquid flow from the above-mentioned cleaning liquid tank to the above-mentioned first three-way valve;
and a waste liquid flow path connected to the above-mentioned second three-way valve and makes the above-mentioned liquid flow from the above-mentioned second three-way valve to the above-mentioned waste liquid unit;
and by switching the flow paths in the above-mentioned first three-way valve and the above-mentioned second three-way valve, when the above-mentioned liquid is ink, the said ink can flow to the above-mentioned head unit
and when the above-mentioned liquid is the above-mentioned cleaning liquid, the above-mentioned cleaning liquid can flow to the above-mentioned head unit.

2. The inkjet printing apparatus described in the claim 1, whose above-mentioned head unit has an IN-side distribution tank, a head to which the above-mentioned liquid flows from the said IN-side distribution tank and an OUT-side distribution tank from which the above-mentioned liquid flows out from the said head;
and the above-mentioned first flow path makes the above-mentioned liquid flow from the above-mentioned buffer tank to the above-mentioned IN-side distribution tank,
and the above-mentioned second flow path makes the above-mentioned liquid flow from the above-mentioned OUT-side distribution tank to the above-mentioned buffer tank.

3. The inkjet printing apparatus described in the claim 2,
which is further equipped with
an auxiliary flow path that makes the above-mentioned liquid flow from the above-mentioned IN-side distribution tank to the above-mentioned buffer tank,
an auxiliary three-way valve placed in the above-mentioned auxiliary flow path,
an auxiliary waste liquid flow path connected to the above-mentioned auxiliary three-way valve and makes the above-mentioned liquid flow from the said auxiliary three-way valve to the above-mentioned waste liquid unit;
and by switching the flow paths in the above-mentioned first three-way valve, the above-mentioned second three-way valve, and the above-mentioned auxiliary three-way valve, when the above-mentioned liquid is the above-mentioned ink, the said ink can flow to the above-mentioned head unit and
when above-mentioned liquid is above-mentioned cleaning liquid, the above-mentioned cleaning liquid can flow to the above-mentioned head unit.

4. The inkjet printing apparatus described in the claim 1,
which is further equipped with
a circulation three-way valve placed upstream of the above-mentioned first three-way valve in the above-mentioned first flow path and
a circulation flow path connected to the said circulation three-way valve that makes the above-mentioned liquid flow from the said circulation three-way valve to the above-mentioned buffer tank;
and by switching the flow path in the above-mentioned circulation three-way valve, the above-mentioned liquid is supplied from the above-mentioned buffer tank to the above-mentioned head unit, or the above-mentioned liquid is circulated from the above-mentioned buffer tank to the said buffer tank.

5. The inkjet printing apparatus described in the ,
which is further equipped with
a liquid supply source for supplying the above-mentioned liquid
and a supply flow path which makes the above-mentioned liquid flow from the above-mentioned liquid supply source to the above-mentioned buffer tank;
and whose above-mentioned liquid supply source has an ink supply source for supplying the above-mentioned ink as the above-mentioned liquid and a purified water supply source for supplying purified water as the above-mentioned liquid;
and when the above-mentioned liquid supply source is the above-mentioned ink supply source, the above-mentioned ink circulates in the above-mentioned supply flow path as the above-mentioned liquid,
and when the above-mentioned liquid supply source is the above-mentioned purified water supply source, the above-mentioned purified water circulates in the above-mentioned supply path as the above-mentioned liquid.

6. The inkjet printing apparatus described in the claim 5, in which the above-mentioned cleaning liquid is water containing a solvent or a surfactant,
and the above-mentioned purified water is water not containing a solvent or a surfactant.

7. A cleaning method for the inkjet printing apparatus described in the claim 1
which has the first cleaning process in which the above-mentioned cleaning liquid in the above-mentioned cleaning liquid tank is made to flow from the above-mentioned cleaning liquid flow path to the above-mentioned first flow path via the above-mentioned first three-way valve and circulate to the above-mentioned head unit,
thereby cleaning the said head unit, and the second cleaning process in which the above-mentioned cleaning liquid circulated to the above-mentioned head unit is made to flow from the said head unit to the above-mentioned second flow path, and then, flow from the above-mentioned second flow path to the above-mentioned waste liquid flow path via the above-mentioned second three-way valve and into the above-mentioned waste liquid unit for discharge.

8. The cleaning method for the inkjet printing apparatus described in the claim 7,
in which the above-mentioned second cleaning process made the above-mentioned cleaning liquid flow from the above-mentioned head unit to the above-mentioned second flow path and into the above-mentioned buffer tank via the above-mentioned second three-way valve, and when the stored amount of the above-mentioned cleaning liquid in the above-mentioned buffer tank reaches the upper limit, the above-mentioned cleaning liquid is made to flow from the above-mentioned second flow path to the above-mentioned waste liquid flow path via the above-mentioned second three-way valve into the above-mentioned waste liquid unit for discharge.

9. A cleaning method for the inkjet printing apparatus described in the claim 3
which has the first cleaning process in which the above-mentioned cleaning liquid in the above-mentioned cleaning liquid tank is made to flow from the above-mentioned cleaning liquid flow path to the above-mentioned first flow path via the above-mentioned first three-way valve and circulate to the above-mentioned head unit thereby cleaning the said head unit,
and the second cleaning process in which the above-mentioned cleaning liquid that has circulated to the above-mentioned head unit is made to flow from the said head unit to the above-mentioned second flow path, and then, from the above-mentioned second flow path to the above-mentioned waste liquid flow path via the above-mentioned second three-way valve into the above-mentioned waste liquid unit for discharge, and at the same time, the above-mentioned auxiliary three-way valve makes the above-mentioned cleaning liquid flow from the above-mentioned auxiliary flow path to the above-mentioned auxiliary waste liquid flow path, and then, into the above-mentioned waste liquid unit for discharge.

10. A cleaning method for the inkjet printing apparatus described in the claim 5
in which, when the inkjet printing apparatus is stopped for longer than a certain period of time determined arbitrarily,
performing full cleaning by attaching the above-mentioned purified water supply source instead of the above-mentioned ink supply source as the liquid supply source to circulate the above-mentioned purified water instead of the above-mentioned ink;
and when the inkjet printing apparatus is stopped for less than the above-mentioned certain period of time,
performing partial cleaning which has a first cleaning process in which the above-mentioned cleaning liquid in the above-mentioned cleaning liquid tank is made to flow from the above-mentioned cleaning liquid flow path to the above-mentioned first flow path via the above-mentioned first three-way valve to circulate to the above-mentioned head unit, thereby cleaning the said head unit,
and a second cleaning process in which the above-mentioned cleaning liquid circulated to the above-mentioned head unit is made to flow from the said head unit to the above-mentioned second flow path, and then, from the above-mentioned second flow path to the above-mentioned waste liquid flow path via the above-mentioned second three-way valve into the above mentioned waste liquid unit for disposal.
